(19) United States
(12) Patent Application Publication
(10) Pub. No.: US 2026/0113616 A1
(43) Pub. Date: Apr. 23, 2026

(54) NEGOTIATION OF PAIRWISE TRANSIENT KEY (PTK) REKEYING FOR SEAMLESS ROAMING

(71) Applicant: Cisco Technology, Inc., San Jose, CA (US)

(72) Inventors: Binita Gupta, San Diego, CA (US); Brian D. Hart, Sunnyvale, CA (US); Stephen Michael Orr, Wallkill, NY (US)

(21) Appl. No.: 19/357,647

(22) Filed: Oct. 14, 2025

Related U.S. Application Data
(60) Provisional application No. 63/709,750, filed on Oct. 21, 2024.

(51) Int. Cl. H04W 8/08; H04W 12/0433

(52) U.S. Cl. CPC H04W 8/08; H04W 12/0433

(57) ABSTRACT

A method is performed by an access point (AP) configured to operate in a seamless mobility domain that supports seamless roaming of wireless stations (STAs) between APs. The method comprises: encoding, into a first frame, AP pairwise transient key (PTK) rekeying options related to roaming of a STA, wherein the AP PTK rekeying options include one or more of (i) a before-roaming AP PTK rekeying option that indicates a first preference, a first requirement, or a first non-preference for PTK rekeying before the roaming, or (ii) an after-roaming AP PTK rekeying option that indicates a second preference, a second requirement, or a second non-preference for the PTK rekeying after the roaming; and transmitting the first frame to the STA.

### CROSS-REFERENCE TO RELATED APPLICATION

This application claims priority to U.S. Provisional Application No. 63/709,750, filed Oct. 21, 2024, the entirety of which is incorporated herein by reference.

### TECHNICAL FIELD

The present disclosure relates to wireless networks.

### BACKGROUND

In the IEEE 802.11/Wi-Fi® wireless networks, there are features to enable a wireless access point (AP) and a wireless client or station (STA) to securely communicate with each other. One such feature is a 4-way handshake during which the devices generate encryption keys to encrypt and decrypt traffic exchanged between them. During the 4-way handshake, a Pairwise Transient Key (PTK) is generated leveraging a Pairwise Master Key (PMK) generated earlier when the client's authentication and groups keys are shared from the AP to the STA. The PTK is used to encrypt all unicast traffic between a STA and an AP. The PTK is unique between a STA and an AP.

### BRIEF DESCRIPTION OF THE DRAWINGS

FIG. 1 is a diagram of a wireless network in which the techniques presented herein may be employed, according to an example embodiment.

FIG. 2 shows an example 4-way handshake between a wireless client device or station (STA) and a wireless access point (AP) to generate encryption keys, according to an example embodiment.

FIG. 3 is a flowchart of a method performed by an AP of a Seamless Mobility Domain (SMD) configured to permit seamless roaming of a station (STA) between APs of the SMD, according to an example embodiment.

FIG. 4 is a flowchart of a method performed by a system that includes an AP configured to operate in an SMD and a STA, according to an example embodiment.

FIG. 5 shows a management frame to announce Pairwise Transient Key (PTK) Rekeying options, according to an example embodiment.

FIG. 6 shows another management frame to announce PTK Rekeying options, according to an example embodiment.

FIG. 7 shows a response frame transmitted by an AP to announce negotiated expected behavior for an AP and/or a STA, according to an example embodiment.

FIG. 8 shows a frame transmitted between APs/AP Multi-Link Devices (MLDs) of an SMD to share encrypted PTKs, according to an example embodiment.

FIG. 9 illustrates a hardware block diagram of a device that may perform the functions of access point or STA in connection with the techniques presented herein, according to an example embodiment.

### DESCRIPTION OF EXAMPLE EMBODIMENTS

### Overview

Presented herein are techniques for an access point (AP) and a station (STA) to indicate their requirement/preference for Pairwise Transient Key (PTK) rekeying before and/or after roaming, and support negotiation of expected behavior for PTK rekeying for seamless roaming between AP multi-link devices (MLDs) of a Seamless Mobility Domain (SMD), with a PTK sharing architecture in which the same PTK is shared between AP MLDs of the SMD. This provides mitigation for concerns related to PTK sharing between AP MLDs (including in non-enterprise deployments) and provides flexibility to enterprise deployments to not mandate PTK rekeying (or PTK regeneration) for every roaming.

In an embodiment, a method is performed by an AP configured to operate in a SMD that supports seamless roaming of wireless stations (STAs) between APs that are part of the SMD. The method comprises: encoding, into a first frame, AP PTK rekeying options related to roaming of a STA, wherein the AP PTK rekeying options include one or more of (i) a before-roaming AP PTK rekeying option that indicates a first preference, a first requirement, or a first non-preference for PTK rekeying before the roaming, or (ii) an after-roaming AP PTK rekeying option that indicates a second preference, a second requirement, or a second non-preference for the PTK rekeying after the roaming; and transmitting the first frame to the STA.

### Example Embodiments

In a wireless local area network (WLAN) or Wi-Fi® wireless network, one or more wireless APs provide wireless Radio Frequency (RF) coverage over which one or more wireless devices (e.g., phones, wearable devices, tablets, etc.) can connect to the APs in order to connect to one or more data networks (e.g., the public Internet, an enterprise network operated by an enterprise entity (e.g., a business, institution, university, etc.)), and/or the like.

The IEEE 802.11bn standards effort has been considering an option of sharing a PTK across AP Multi-Link Devices (MLDs) of an SMD for seamless roaming. This enables a non-AP MLD (i.e., a client) to roam between AP MLDs of the SMD without requiring the client to regenerate the PTK again, providing a faster roaming.

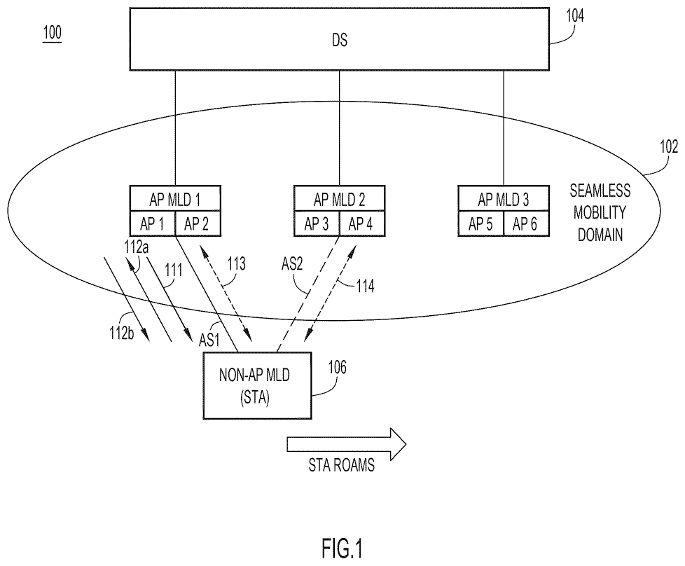

An SMD is a mobility domain for seamless roaming and comprises a set of AP MLDs within the same Extended Service Set (ESS) that support seamless roaming for Non-AP MLDs (e.g., STAs) that are roaming between AP MLDs of the SMD. The SMD is identified by an SMD Media Access Control (MAC) address, also known as SMD Identifier. An ESS can have one or more SMDs configured for covering AP MLDs of the ESS. FIG. 1 shows an example wireless network environment 100 in which an SMD 102 includes an AP MLD 1 having affiliated APs AP1 and AP2, an AP MLD 2 having affiliated APs AP3 and AP4, and an AP MLD 3 having affiliated APs AP5 and AP6. Wireless network environment 100 further includes a backbone or distribution system (DS) 104 over which the AP MLDs communicate with each other, and a STA 106 (e.g., a non-AP MLD). A STA may also be referred to as a “wireless client device.”

PTK sharing across the APs/AP MLDs of the SMD (e.g., across SMD 102) has many benefits, including achieving better roaming performance and more reliable roaming experience even for last-minute/panic roams, since the non-AP MLD does not need to regenerate a new PTK for the new AP MLD to which the non-AP MLD is roaming. There may be some concerns (e.g., in certain deployments which are not fully managed) with sharing the same PTK on multiple APs. One possible concern is that in such a deployment, if one of the APs is compromised/hacked, this can lead to compromised user traffic exchange with other APs (due to both APs using the same PTK).

“PTK rekeying” refers to regenerating/re-establishing or refreshing the PTK. PTK rekeying produces a new PTK to replace a previous PTK. PTK rekeying includes repeating the 4-way handshake to produce the new PTK or a modified handshake that generates a new PTK. PTK rekeying may be performed in connection with STA roaming, i.e., when a STA roams from a first or current AP to which the STA is currently connected to a second or target AP to which the STA connects to next. This may be referred to as a “roaming event.” PTK rekeying may be performed either before or after roaming. Note that as the STA roams, it remains associated with an SMD-management entity (ME) (SMD-ME) within the SMD. PTK rekeying before roaming limits sharing the PTK used by the current AP with the target AP, and can address the concern of PTK sharing when the target AP may be compromised, because traffic exchanged with the current AP will not be impacted if the new PTK used by the target AP becomes compromised. Similarly, PTK rekeying after roaming limits sharing of the PTK of the target AP with the old AP, and can address the concern of PTK sharing when the old AP may be compromised, because traffic exchanged with the target AP will not be impacted if the PTK used by the old AP (i.e., the current AP) becomes compromised.

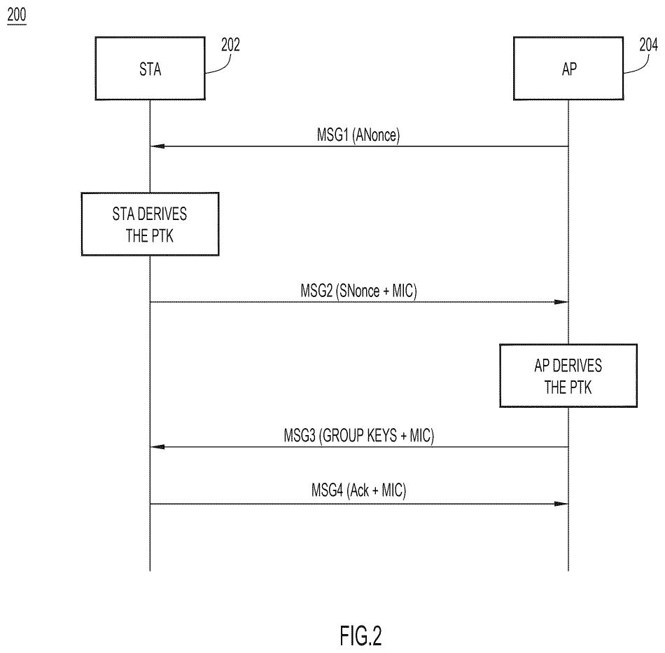

FIG. 2 shows an example 4-way handshake 200 between a STA 202 and an AP 204 to generate to PTK and distribute group keys. 4-way handshake 200 may represent an initial 4-way handshake performed when STA 202 first associates to an SMD-ME of an SMD to which AP 204 belongs. Alternatively, 4-way handshake 200 may represent a subsequent 4-way handshake to achieve PTK rekeying before a roam of STA 202 to a new AP or after the roam or at any other time. In one arrangement, STA 202 requests its associated AP to initiate the 4-way handshake for PTK rekeying. In another arrangement, AP 204 initiates (i.e., performs) the 4-way handshake for PTK rekeying. The MSG1 (message 1) of the PTK 4-way handshake is always initiated by the AP.

Initially, AP 204 sends to STA 202 a message 1 including an ANonce. Then, the STA generates an SNonce and uses the ANonce and the SNonce to generate a PTK. Next, STA 202 sends to AP 204 a message 2, including the SNonce and a message integrity code (MIC). The AP uses the SNonce and the ANonce to generate the same PTK as the STA and verifies the received MIC. Next, AP 204 sends to STA 202 a message 3 including group keys for the links that have been set up (i.e., established) and another MIC. The STA verifies the MIC and sends to AP 204 a message 4 including a final MIC, which is verified by the AP. This completes the 4-way handshake, and the two sides (i.e., the AP and STA) have set up a common PTK. For an SMD level shared PTK, the PTK derivation becomes tied to the SMD Identifier.

Returning to FIG. 1, Wi-Fi wireless networks are deployed across many vertical industries. Based on deployments, there may or may not be a need to rekey a PTK before and/or after a roaming event. For example, in an enterprise deployment, the concern that an AP is compromised can be negligible, hence PTK rekeying before or after roaming of a STA may not be needed. In home deployments, where APs from different vendors can be mixed and matched by an end user, there may be more of a concern of an AP being compromised. Such a deployment may benefit from PTK rekeying before and/or after roaming by the STA.

To enable PTK rekeying, a signaling mechanism for each side (the STA and AP) is employed to provide their requirements and by which both sides negotiate on the behavior related to PTK rekeying. Embodiments presented herein include such a signaling mechanism to meet requirements for PTK rekeying per deployment needs.

The SMD can have certain policy/preferences/requirements defined/configured for PTK rekeying before and/or after seamless roaming of the STA. The SMD can announce its policy and preferences for PTK rekeying before and/or after roaming to STAs through the set of APs/AP MLDs that are part of the SMD. Each affiliated AP (e.g., AP module) of the AP MLD can announce the SMD's requirement/preference for PTK rekeying before and/or after roaming in an element/field/subfield in one or more of Beacon, Probe Response, or another management frame. For example, this can be announced in an SMD Information element, an ultra high reliability (UHR) Operation element, a UHR Capabilities element, or another element by the APs/AP MLDs that are part of the SMD.

FIG. 1 shows a high-level operational flow performed by one or more AP MLDs (e.g., AP MLD 1) and a STA (e.g., STA 106) in SMD 102 to (i) announce and/or negotiate PTK rekeying preference/requirements/policy of the STA and the AP MLD for before roaming, after roaming, or after a certain number of roams, and (ii) when the STA actually roams from a current AP MLD to a target AP MLD (e.g., AP MLD 2), optionally perform PTK rekeying in accordance with the announced or negotiated preference/requirements for PTK rekeying. In the example of FIG. 1, the STA initially associates to the SMD-ME of SMD 102 via AP MLD 1 (represented at AS1) and executes the 4-way handshake with the AP MLD1 during which the devices generates an SMD level shared PTK.

Operations 111, 112a, and 112b depicted in FIG. 1 are a priori or “configuration” operations that occur before the STA (i.e., the non-AP MLD) triggers a roam event, e.g., before the STA decides to roam.

In operation 111, the AP MLD provides its PTK rekeying preferences/requirements/policy (and non-preferences) for SMD roaming to the STA. For example, this could be provided in Beacon, Probe Response or (Re)Association Response frames. In one case, the negotiation of PTK rekeying preferences/requirements/policy is optional. The AP MLD simply provides its preferences/requirements/policy to the non-AP MLD in Beacon, Probe Response or (Re)Association Response frames as shown by operation 111, and then the AP MLD initiates PTK rekeying per that preferences/requirements/policy.

In another case, there is a negotiation of PTK rekeying preferences/requirements between the AP MLD and the non-AP MLD. This is shown by operations 112a and 112b. At operation 112a, a non-AP MLD initiates negotiation of PTK rekeying preferences/requirements with the AP MLD. At operation 112a, the STA provides its (STA) PTK rekeying preferences/requirements (and possibly non-preferences) for SMD roaming to the AP MLD. The AP MLD then responds with its final negotiated PTK rekeying preferences/requirements in operation 112b. The operation 112a can be a (Re)Association Request frame from the STA to the AP, and the operation 112b can be a (Re)Association Response frame from the AP to the STA. The PTK rekeying preferences/requirements negotiation can occur in two cases: i) when the AP is advertising its PTK rekeying preferences/requirements to the STAs using operation 111, as described above, and then the STA can decide to negotiate if needed based on what is advertised; or ii) when the AP is not advertising any PTK rekeying preferences/requirements to the STAs (i.e., no PTK rekeying preferences/requirements/policy is sent to the STAs in operation 111), and the STA can decide to negotiate with the AP on PTK rekeying.

Operations 112a and 112b result in negotiation of PTK rekeying preferences/requirements between the STA and the AP MLD. At this point in time, the exchanged PTK rekeying preferences/requirements represent possible negotiated behaviors that need to be followed by the AP MLD and the STA in connection with a subsequent actual roam by the STA.

After operations 111 and/or 112a and 112b, the STA decides to roam to a new AP MLD (e.g., to AP MLD 2), which triggers next operations 113 and/or 114. The STA knows when it has decided to roam, and the AP MLD (e.g., AP MLD 1) detects that the STA is about to roam through one or more messages from the STA that indicate the roam event. When the STA actually roams, the STA moves its links to the target AP MLD (e.g., to AP MLD 2), as shown at AS2. Note that the STA remains associated with the SMD/SMD-ME through the roaming event, and does not perform reassociation with the target AP MLD.

At 113, optional PTK rekeying may be performed before roaming by the AP MLD or by the STA (e.g., the STA requests PTK rekeying and then the AP MLD initiates a 4-way handshake) based on/according to the PTK rekeying preferences/requirements that are exchanged at 111 and/or 112a and 112b, and that indicate that PTK rekeying is to be performed before the roaming event takes place.

At 114, optional PTK rekeying is performed after roaming by the AP MLD or by the STA (e.g., the STA requests PTK rekeying and then the AP initiates 4-way handshake) based on the PTK rekeying preferences/requirements that are exchanged at 111 and/or 112a and 112b, and that indicate that PTK rekeying is to be performed after the roaming event takes place.

An AP (e.g., any of the AP MLDs of FIG. 1) may indicate at least one option selected from a set of possible/available options for PTK rekeying before roaming. More specifically, the AP can indicate an option for PTK rekeying before roaming selected from the following available options:
a. AP requires STA to perform PTK rekeying before roaming (whenever possible).
b. AP prefers STA to perform PTK rekeying before roaming.
c. AP prefers that STA does not perform PTK rekeying before roaming.
d. AP has no preference (i.e., a non-preference) for PTK rekeying before roaming.

The above four options may each be more generally referred to as a “before-roaming AP PTK rekeying option that indicates a preference, requirement, or non-preference (of the AP) for PTK rekeying before roaming.”

Similar to the above before-roaming options, an AP can also indicate an option for PTK rekeying after roaming selected from the following set of available options:
a. AP intends to perform PTK rekeying after roaming.
b. AP prefers that PTK rekeying after roaming is performed by the AP.
c. AP prefers that PTK rekeying after roaming is performed by the STA.
d. AP prefers that PTK rekeying is not performed after roaming (by AP or STA).
e. AP can perform PTK rekeying after roaming per STA requirement.
f. AP has no preference for PTK rekeying after roaming.

The above six options may each be more generally referred to as an “after-roaming AP PTK rekeying option that indicates a preference, requirement, or non-preference (of the AP) for PTK rekeying after roaming.”

In a simplified approach, an AP can also define a smaller number of options for PTK rekeying before and/or after roaming. For example, an AP can indicate just two options for PTK rekeying before roaming:
a. AP prefers that STA does not perform PTK rekeying before roaming.
b. AP has no preference for PTK rekeying before roaming.

For PTK rekeying after roaming, an AP can indicate the following simplified options:
a. AP prefers that PTK rekeying is not performed after roaming (by AP or STA).
b. AP has no preference for PTK rekeying after roaming.

In an example, an enterprise AP, which does not require or prefer PTK rekeying before and after roaming, can indicate:
a. AP prefers that STA does not perform PTK rekeying before roaming.
b. AP prefers that PTK rekeying is not performed after roaming (by AP or STA).
c. More generically, AP prefers that no PTK rekeying is needed to be performed before roaming or after roaming.

An AP can indicate its preference/requirement for PTK rekeying in a PTK Rekeying Preference field or element. This new field can be formatted using A) or B) encoding approaches below:

A) In one embodiment, the PTK Rekeying Preference field/element includes two subfields, one subfield for PTK Rekeying Preference before roaming and another subfield for PTK Rekeying Preference after roaming:
a. The PTK Rekeying Preference before roaming subfield can be a 1/2/3/4 bits long subfield where each value indicates a different preference for PTK rekeying before roaming.
b. The PTK Rekeying Preference after roaming subfield can be a 1/2/3/4 bits long subfield where each value indicates a different preference for PTK rekeying after roaming.
c. Alternatively, each of these fields can be a bitmap, with a bit corresponding to each preference value.

B) In another embodiment, the PTK Rekeying Preference field/element can be encoded as a single bitmap, where each bit corresponds to one of the options for PTK Rekeying Preference before or after roaming. For example, this field can be encoded as a 4/6/8/10/12/16 bits long bitmap where some set of bits correspond to indicating a preference for PTK rekeying before roaming and another set of bits corresponds to indicating a preference for PTK rekeying after roaming.

In still another embodiment, an AP can indicate its preference for PTK rekeying before and/or after roaming in an individually addressed management frame transmitted to a STA, e.g., in a (Re)Association Response frame, a roaming related management frame, a Neighbor Report Response frame, a Basic Service Set (BSS) Transition Management (BTM) Request frame, or another management frame.

Similarly, a STA can provide its preference for PTK rekeying before and/or after roaming in a management frame sent to the AP, e.g., in a (Re)Association Request frame, in a roaming related management frame, or in another management frame.

A STA can indicate at least one of the following options (or more than one of the following options) selected from a set of possible/available options for PTK rekeying before roaming to include:
a. STA intends to perform PTK rekeying before roaming (whenever possible).
b. STA prefers to perform PTK rekeying before roaming.
c. STA prefers not to perform PTK rekeying before roaming.
d. STA can perform PTK rekeying before roaming per AP requirement.
e. STA has no preference for PTK rekeying before roaming.

The above five options may each be more generally referred to as a “before-roaming STA PTK rekeying option that indicates a preference, requirement, or non-preference (of the STA) for PTK rekeying before roaming.”

A STA can indicate one of the following for PTK rekeying after roaming:
a. STA intends to perform PTK rekeying after roaming.
b. STA prefers that PTK rekeying after roaming is performed by the AP.
c. STA prefers that PTK rekeying after roaming is performed by the STA.
d. STA prefers that PTK rekeying is not performed after roaming (by AP or STA).
e. STA can perform PTK rekeying after roaming per AP requirement.
f. STA has no preference for PTK rekeying after roaming.

The above six options may each be more generally referred to as an “after-roaming STA PTK rekeying option that indicates a preference, requirement, or non-preference (of the STA) for PTK rekeying after roaming.”

Similar to the AP as explained above, a STA can also define a smaller number of options for PTK rekeying before and after roaming in a simplified approach. For example, the STA can indicate just two options for PTK rekeying before roaming:
a. STA prefers not to perform PTK rekeying before roaming.
b. STA has no preference for PTK rekeying before roaming.

For PTK rekeying after roaming, the STA can indicate the following options:
a. STA prefers that PTK rekeying is not performed after roaming (by AP or STA).
b. STA has no preference for PTK rekeying after roaming.

STA defined options for PTK rekeying before and after roaming can be encoded similar to that on the AP side using A) or B) encoding approaches above.

Based on the requirement/preference for PTK rekeying before and/or after roaming announced by the APs (of the SMD), a STA can indicate its requirement and expected behavior to the AP in an individually addressed management frame to negotiate an expected PTK rekeying requirement/preference between the AP and the STA. The AP will then confirm/override the requirement and expected behavior for both AP and STA and send the negotiated PTK rekeying requirement/preference in a response frame to the STA. The AP and STA then act based on the negotiated expected behavior for PTK rekeying before and/or after roaming.

For example, if the AP advertised:
a. AP requires STA to perform PTK rekeying before roaming (whenever possible).
b. AP can perform PTK rekeying after roaming per STA requirement.

And the STA sends the following to the AP:
a. STA can perform PTK rekeying before roaming per AP requirement.
b. STA prefers AP to perform PTK rekeying after roaming.

In the response message that is sent by the AP to the STA, the AP can indicate the following negotiated expected behavior for the STA and the AP for PTK rekeying before and after roaming:
a. STA to perform PTK rekeying before roaming (whenever possible).
b. AP to perform PTK rekeying after roaming.

Note that the negotiated behavior for PTK rekeying may include only PTK rekeying requirement/preference before roaming or after roaming or include both parts.

The final expected behavior can be signaled in the response frame to the STA by including two separate fields/subfields, one indicating expected behavior for the AP and another indicating expected behavior for the STA. Alternatively, a bitmap field(s) can be defined to indicate expected behavior for the AP and the STA. This can be indicated in a (Re)Association Response frame, in a roaming related management frame, or another management frame.

Whether asserted by the AP or the STA, a PTK rekeying option that asserts a requirement, a preference, or a non-preference has an associated level of restrictedness ordered from most restricted to least restricted. For example, a requirement is more restricted than a preference, and a preference is more restricted than a non-preference. The AP and STA may each store mappings of options to their ordered restrictedness.

In the negotiation to select the expected behavior, it is desired that both the AP and STA follow the rules to pick the most restricted requirement/preference for PTK sharing before and after roaming considering preferences of both sides. For example, if the AP requires the STA to perform PTK rekeying before roaming and the STA has no preference for PTK rekeying before roaming, then the final expected behavior should be for the STA to perform PTK rekeying before roaming (more restricted option). Similarly, if the STA prefers that PTK rekeying after roaming is performed by the AP and the AP has no preference for PTK rekeying after roaming, then final expected behavior should be for the AP to perform PTK rekeying after roaming.

In another embodiment, PTK sharing (across APs) concerns can be mitigated by more frequent and periodic rekeying of the PTK. This becomes important in a PTK sharing architecture to mitigate concerns that APs can get hacked/compromised in the network. For example, instead of rekeying the PTK once every 24 hours, the rekeying can occur every 30 min/1 hr/2 hr/4 hr/8 hr, etc. With more frequent rekeying, any compromise of user traffic on a hacked AP can be limited to the time duration of PTK rekeying. For frequent PTK rekeying, the AP can announce an SMD level policy to indicate a periodic schedule or interval for PTK rekeying (e.g., indicate that the AP will be rekeying PTK every 1 hr.). This can be indicated in an SMD Information element, UHR Capabilities or UHR Operation element, in a security related element, e.g., robust security network element (RSNE), RSNXE, or another element. If the STA prefers a shorter PTK rekeying periodicity, it can ask and negotiate with the AP for a shorter PTK rekeying interval in a Request/Response management frame exchange. If the AP does not rekey PTK at agreed interval, then the STA can initiate PTK rekeying at shorter interval as desired.

In an embodiment, the more frequent PTK rekeying mechanism can be used along with (or instead of) the PTK rekeying before and/or after the roaming mechanism described above.

In another embodiment, the PTK can be rekeyed after a non-AP MLD has performed a certain number of seamless roams with a given SMD. In this case, the SMD (or SMD-ME) keeps track of the number of roams a non-AP MLD has performed and then an AP MLD in the SMD initiates PTK rekeying for a non-AP MLD after it has performed that certain number of roams. This can be based on a parameter/policy that is maintained at the SMD level and can be advertised by the SMD/AP MLD in the SMD Information element (or another UHR element), e.g., advertise a “Number of Roams for PTK Rekeying” in the SMD Information element. If the STA prefers a different number of roams after which PTK rekeying needs to occur (i.e., different from what is advertised by the AP), then the STA can negotiate with the AP for a different value in a Request/Response management frame exchange (e.g., in a (Re)Association Request/Response exchange or a roaming request/response exchange). In another case, the parameter of “Number of roams for PTK rekeying” is internal to the SMD and is not advertised to the STAs (in the SMD Information element) but is defined in the amendment of the standard as a management information based (MIB) parameter, e.g., dot11UHRSMDNumOfRoamsForPTKRekeying, and the AP would perform PTK rekeying after that number of roams for a non-AP MLD.

In an embodiment, PTK and/or PTK Security Association (SA) (PTKSA) distribution among neighboring APs/AP MLDs (or all APs) of an SMD should be encrypted using Advanced Encryption Security (AES) Key-Wrap algorithm. The channel over which the encrypted wrapped PTK is exchanged can be left to implementation.

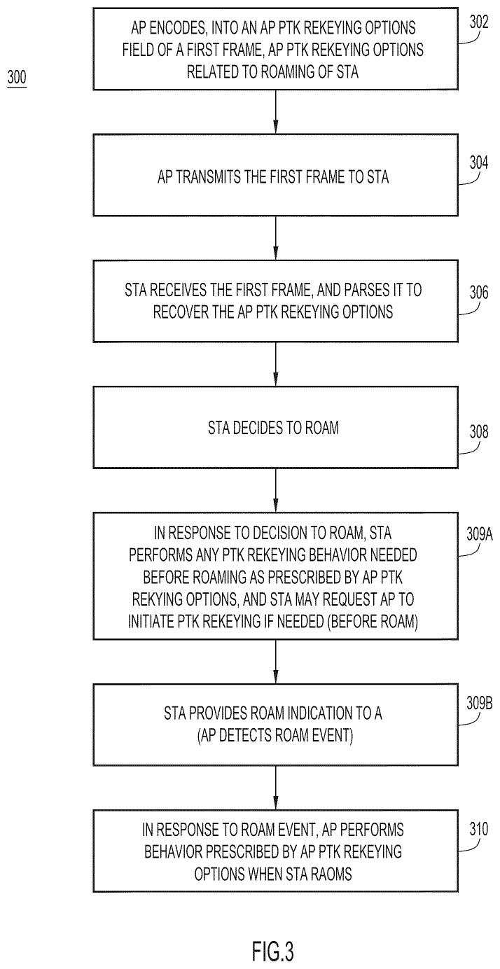

FIG. 3 is a flowchart of an example method 300 performed by an AP of an SMD configured to permit seamless roaming of a wireless STA between APs of the SMD.

At 302, the AP encodes, into an AP PTK rekeying options field of a first frame (e.g., a first management frame), AP PTK rekeying options related to roaming of a STA and that include/indicate one or more of (i) a before-roaming AP PTK rekeying option that indicates a first preference, a first requirement, or a first non-preference (of the AP) for PTK rekeying to produce a new PTK (after an initial PTK has been generate) before the roaming, or (ii) an after-roaming AP PTK rekeying option that indicates a second preference, a second requirement, or a second non-preference (of the AP) for the PTK rekeying to produce the new PTK after the roaming. The AP PTK rekeying options may include both the before-roaming AP PTK rekeying option and the after-roaming AP PTK rekeying option, and may also include multiple before-roaming AP PTK rekeying options and/or multiple after-roaming AP PTK rekeying options.

In one embodiment, the AP PTK rekeying option may indicate PTK rekeying to be done more frequently than what is currently programmed based on a faster PTK session timer that previously or PTK rekeying to be done after a certain number of roams.

At 304, the AP transmits the first frame to the STA.

At 306, the STA receives the first frame, and parses the same to recover the AP PTK rekeying options.

At 308, the STA decides to roam.

At 309A, in response to the decision to roam, the STA performs any PTK rekeying behavior needed to derive a new PTK before roaming as per the behavior prescribed by the AP PTK rekeying options. As part of this, the STA may request the AP to initiate PTK rekeying if needed (before the STA starts the roam).

At 309B, the STA provides a roam indication to the AP or, more generally, the AP detects the roam event.

At 310, responsive to the roam event, the AP performs the behavior prescribed by the AP PTK rekeying options when the STA roams and, as part of this, the AP may perform PTK rekeying to derive a new PTK if needed.

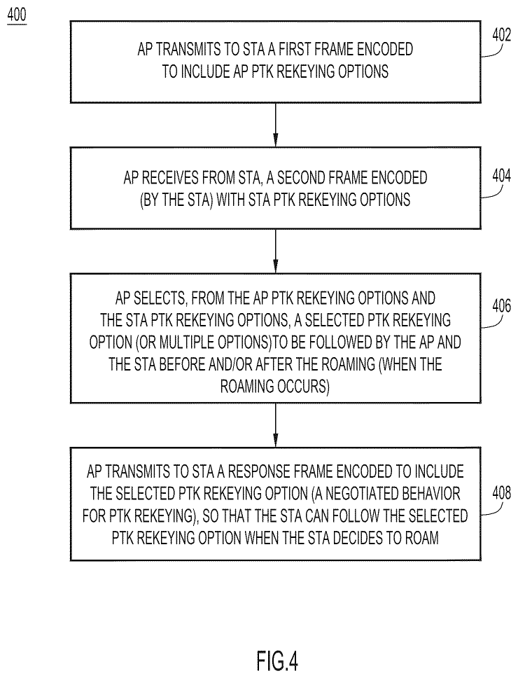

FIG. 4 is a flowchart of an example method 400 performed by a system that includes an AP configured to operate in an SMD that supports seamless roaming of wireless STAs between APs.

At 402, the AP transmits to the STA a first frame encoded to include AP PTK rekeying options to include/indicate one or more of (i) a before-roaming AP PTK rekeying option that indicates a first preference, a first requirement, or a first non-preference for PTK rekeying before the roaming, or (ii) an after-roaming AP PTK rekeying option that indicates a second preference, a second requirement, or a second non-preference for the PTK rekeying after the roaming.

At 404, the AP receives from the STA, a second frame encoded (by the STA) with STA PTK rekeying options to include one or more of (iii) a before-roaming STA PTK rekeying option that indicates a third preference, a third requirement, or a third non-preference for the PTK rekeying before the roaming, or (iv) an after-roaming STA PTK rekeying option that indicates a fourth preference, a fourth requirement, or a fourth non-preference STA for the PTK rekeying before the roaming.

At 406, the AP selects, from the AP PTK rekeying options and the STA PTK rekeying options, at least one selected PTK rekeying option to be followed by the AP and the STA before and/or after the roaming (when a roaming event occurs/is triggered). The selected PTK rekeying option represents a before-roaming and/or after-roaming PTK negotiated behavior(s) to be followed by the AP and the STA when the roaming occurs.

The AP PTK rekeying options are associated with first levels of restrictedness from most restricted to least restricted (where a requirement is more restricted than a preference or a non-preference), and the STA PTK rekeying options are associated with second levels of the restrictedness from most restricted to least restricted. The AP selects the PTK behavior based on a comparison of the first levels of the restrictedness against the second levels of the restrictedness. For example, the AP selects/favors the PTK rekeying option corresponding to/that has the most restricted level.

At 408, the AP transmits to the STA a response frame encoded to include the selected PTK rekeying option, so that the STA can follow the selected PTK rekeying option when the STA decides to roam. The AP follows the selected PTK rekeying option in connection with the roam by the STA.

FIG. 5 shows an example management frame 500 to announce PTK rekeying options. Management frame 500 may be transmitted by an AP or a STA. Management frame 500 includes a PTK Rekeying Preference field 502 that has a first subfield 504 encoded to include/indicate a before-roaming (BR) option value that indicates a preference for PTK rekeying before roaming, and a second subfield 506 encoded to include/indicate a preference for PTK rekeying after roaming (AR). Alternatively, each subfield may be a bitmap. Management frame 500 may also include a PTK rekeying period field 510 encoded to indicate a required, or alternatively preferred, PTK rekeying period. The management frame 500 may also include a “Number of Roams for PTK Rekeying” field 512, indicating a value for an AP's preference/requirement/policy for the number of roams after which the PTK rekeying should be done.

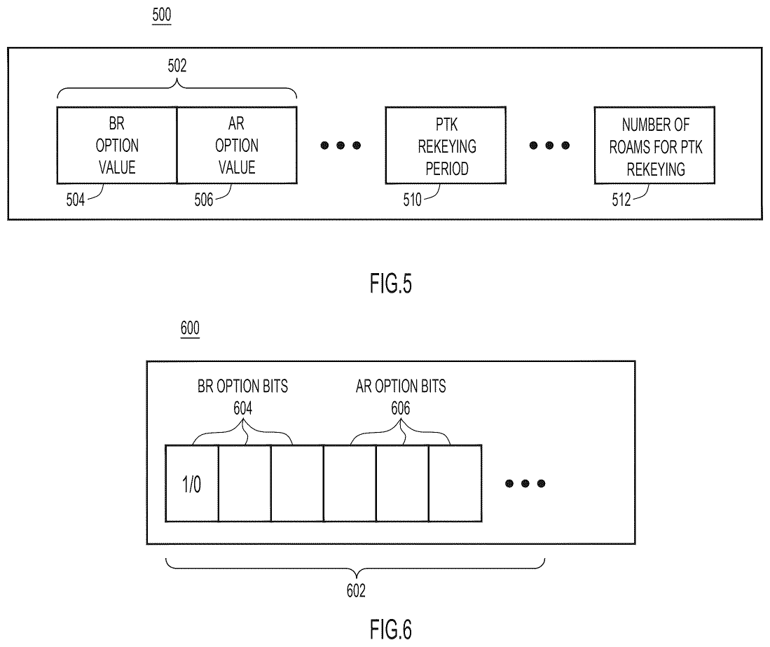

FIG. 6 shows another example management frame 600 to announce PTK rekeying options. Management frame 600 may be transmitted by an AP or a STA. Management frame 600 includes a PTK Rekeying Preference field 602 encoded as a bitmap having first bits 604 (or bit positions) that indicate different BR options, and second bits 606 that indicate different AR options. A value 1 for a bit indicates the presence of an option, while a value 0 for a bit indicates that the option is not present. In one case, the encoding could be reversed as well.

FIG. 7 shows an example response frame 700 transmitted by an AP to announce negotiated expected behavior for an AP and/or a STA. Response frame 700 includes a first field (or subfield) 704 encoded to indicate an expected behavior (i.e., before-roaming and/or after-roaming PTK Rekeying options) to be followed by the AP, and a second field (or subfield) 706 encoded to indicate an expected behavior (i.e., before-roaming and/or after-roaming PTK Rekeying options) to be followed by the STA. Alternatively, each subfield may be a bitmap.

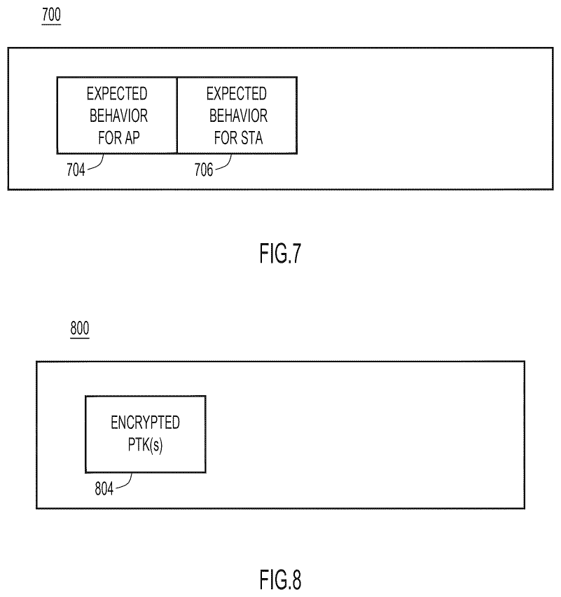

FIG. 8 shows an example message 800 transmitted between AP MLDs of an SMD to distribute the shared PTK from one AP MLD to another AP MLD within the SMD. Message 800 is encoded to include the encrypted PTK 804 (and/or corresponding PTK Security Association (SA) (PTKSA)) of a non-AP MLD. The PTK and/or PTKSA is/are encrypted using an Advanced Encryption Security (AES) Key-Wrap algorithm to securely distribute the PTK and/or PTKSA. The message carrying the encrypted PTK/PTKSA is sent over a DS (e.g., DS 104).

In summary, techniques are provided for a mechanism for an AP and STA to indicate their requirement/preference for PTK rekeying before and/or after roaming, and support negotiation of expected behavior for PTK rekeying for seamless roaming with the PTK sharing architecture (where a single PTK is shared across AP MLDs of an SMD). This enables mitigation for concerns raised on PTK sharing (including PTK sharing for non-enterprise deployments) and provides flexibility to enterprise deployments to not mandate PTK rekeying (or PTK regeneration) for every roaming.

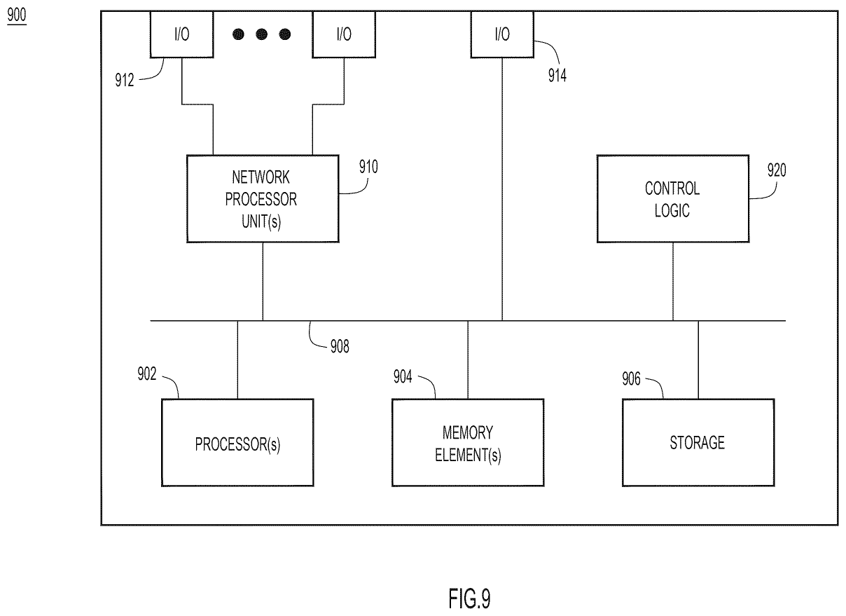

Referring to FIG. 9, FIG. 9 illustrates a hardware block diagram of a device 900 that may perform functions associated with operations discussed herein in connection with the techniques presented herein. In various embodiments, a computing device or apparatus, such as device 900 or any combination of devices 900, may be configured as any entity/entities as discussed for the techniques presented herein in order to perform operations of the various techniques discussed herein. The device 900 may represent a wireless client device or STA, an AP of an AP MLD or a wireless network controller.

In at least one embodiment, the device 900 may be any apparatus that may include one or more processor(s) 902, one or more memory element(s) 904, storage 906, a bus 908, one or more network processor unit(s) 910 interconnected with one or more network input/output (I/O) interface(s) 912, one or more I/O interface(s) 914, and control logic 920. In various embodiments, instructions associated with logic for device 900 can overlap in any manner and are not limited to the specific allocation of instructions and/or operations described herein.

In at least one embodiment, processor(s) 902 is/are at least one hardware processor configured to execute various tasks, operations and/or functions for device 900 as described herein according to software and/or instructions configured for device 900. Processor(s) 902 (e.g., a hardware processor) can execute any type of instructions associated with data to achieve the operations detailed herein. In one example, processor(s) 902 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 904 and/or storage 906 is/are configured to store data, information, software, and/or instructions associated with device 900, and/or logic configured for memory element(s) 904 and/or storage 906. For example, any logic described herein (e.g., control logic 920) can, in various embodiments, be stored for device 900 using any combination of memory element(s) 904 and/or storage 906. Note that in some embodiments, storage 906 can be consolidated with memory element(s) 904 (or vice versa), or can overlap/exist in any other suitable manner.

In at least one embodiment, bus 908 can be configured as an interface that enables one or more elements of device 900 to communicate in order to exchange information and/or data. Bus 908 can be implemented with any architecture designed for passing control, data and/or information between processors, memory elements/storage, peripheral devices, and/or any other hardware and/or software components that may be configured for device 900. In at least one embodiment, bus 908 may be implemented as a fast kernel-hosted interconnect, potentially using shared memory between processes (e.g., logic), which can enable efficient communication paths between the processes.

In various embodiments, network processor unit(s) 910 may enable communication between device 900 and other systems, entities, etc., via network I/O interface(s) 912 (wired and/or wireless) to facilitate operations discussed for various embodiments described herein. In various embodiments, network processor unit(s) 910 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between device 900 and other systems, entities, etc. to facilitate operations for various embodiments described herein. In various embodiments, network I/O interface(s) 912 can be configured as one or more Ethernet port(s), Fibre Channel ports, any other I/O port(s), and/or antenna(s)/antenna array(s) now known or hereafter developed. Thus, the network processor unit(s) 910 and/or network I/O interface(s) 912 may include suitable interfaces for receiving, transmitting, and/or otherwise communicating data and/or information in a network environment.

I/O interface(s) 914 allow for input and output of data and/or information with other entities that may be connected to device 900. For example, I/O interface(s) 914 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 920 can include instructions that, when executed, cause processor(s) 902 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 920) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 904 and/or storage 906 can store data, software, code, instructions (e.g., processor instructions), logic, parameters, combinations thereof, and/or the like used for operations described herein. This includes memory element(s) 904 and/or storage 906 being able to store data, software, code, instructions (e.g., processor instructions), logic, parameters, combinations thereof, or the like that are executed to conduct operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In some aspects, the techniques described herein relate to a method performed by an access point (AP) configured to operate in a seamless mobility domain (SMD) that supports roaming of wireless stations (STAs) between APs of the SMD, the method including: encoding, into a first frame, AP pairwise transient key (PTK) rekeying options related to roaming of a STA, wherein the AP PTK rekeying options include one or more of (i) a before-roaming AP PTK rekeying option that indicates a first preference, a first requirement, or a first non-preference for PTK rekeying before the roaming, or (ii) an after-roaming AP PTK rekeying option that indicates a second preference, a second requirement, or a second non-preference for the PTK rekeying after the roaming; and transmitting the first frame to the STA.

In some aspects, the techniques described herein relate to a method, further including: sharing, among the APs of the SMD, a PTK for the STA.

In some aspects, the techniques described herein relate to a method, wherein: the before-roaming AP PTK rekeying option is selected from a set of before-roaming AP PTK rekeying options including: the AP requires the STA to perform the PTK rekeying before the roaming; the AP prefers the STA to perform the PTK rekeying before the roaming; the AP prefers that the STA does not perform the PTK rekeying before the roaming; and the AP has no preference for the PTK rekeying before the roaming.

In some aspects, the techniques described herein relate to a method, wherein: the after-roaming AP PTK rekeying option is selected from a set of after-roaming AP PTK rekeying options including: the AP intends to perform the PTK rekeying after the roaming; the AP prefers that the PTK rekeying after the roaming is performed by the AP; the AP prefers that the PTK rekeying after the roaming is performed by the STA; the AP prefers that the PTK rekeying is not performed after the roaming by the AP or the STA; the AP performs the PTK rekeying after the roaming according to a STA requirement; and the AP has no preference for the PTK rekeying after the roaming.

In some aspects, the techniques described herein relate to a method, wherein: encoding includes encoding, into the first frame, the before-roaming AP PTK rekeying option and the after-roaming AP PTK rekeying option.

In some aspects, the techniques described herein relate to a method, wherein: encoding further includes indicating a PTK rekeying option which indicates to perform the PTK rekeying after the STA has performed a certain number of roams between the APs.

In some aspects, the techniques described herein relate to a method, wherein: encoding further includes indicating a PTK rekeying option which indicates performing the PTK rekeying based on a certain time interval.

In some aspects, the techniques described herein relate to a method, further including: by the AP, performing AP PTK rekeying to generate a new PTK after an initial PTK has been generated, based on the AP PTK rekeying options transmitted by the AP.

In some aspects, the techniques described herein relate to a method, further including: by the STA, performing the PTK rekeying to generate a new PTK after an initial PTK has been generated, based on the AP PTK rekeying options transmitted by the AP.

In some aspects, the techniques described herein relate to a method, further including, at the AP: receiving, from the STA, a second frame encoded with STA PTK rekeying options related to the roaming of the STA, wherein the STA PTK rekeying options include one or more of (iii) a before-roaming STA PTK rekeying option that indicates a third preference, a third requirement, or a third non-preference for the PTK rekeying before the roaming, or (iv) an after-roaming STA PTK rekeying option that indicates a fourth preference, a fourth requirement, or a fourth non-preference STA for the PTK rekeying before the roaming.

In some aspects, the techniques described herein relate to a method, further including, at the AP: selecting, from the AP PTK rekeying options and the STA PTK rekeying options, a selected PTK rekeying option to be followed by the AP and the STA before or after the roaming.

In some aspects, the techniques described herein relate to a method, further including, at the AP: transmitting, to the STA, the selected PTK rekeying option; and following the selected PTK rekeying option in connection with a roam by the STA.

In some aspects, the techniques described herein relate to a method, wherein: the AP PTK rekeying options are associated with first levels of restrictedness from most restricted to least restricted; the STA PTK rekeying options are associated with second levels of the restrictedness from most to least restricted; and selecting includes selecting based on the first levels of the restrictedness and the second levels of the restrictedness.

In some aspects, the techniques described herein relate to a method, wherein: transmitting includes transmitting the first frame as a beacon, a probe response, an association response, or a reassociation response.

In some aspects, the techniques described herein relate to a method, wherein encoding includes: encoding a first subfield of an AP PTK rekeying field with a first value indicative of the first preference, the first requirement, or the first non-preference for the PTK rekeying before the roaming; and encoding a second subfield of the AP PTK rekeying field with a second value indicative of the second preference, the second requirement, or the second non-preference for rekeying after the roaming.

In some aspects, the techniques described herein relate to a method, wherein encoding includes: encoding an AP PTK rekeying field of the first frame as a bit map that has respective bits to indicate the first preference, the first requirement, or the first non-preference of the AP for the PTK rekeying before the roaming, and the second preference, the second requirement, or the second non-preference of the AP for the PTK rekeying after the roaming.

In some aspects, the techniques described herein relate to a method, wherein: the AP includes an AP multi-link device (MLD) and the STA includes a non-AP MLD.

In some aspects, the techniques described herein relate to a method, further including, by the AP: performing the PTK rekeying to generate a new PTK; encrypting the new PTK to produce an encrypted PTK; and distributing the encrypted PTK to other APs of the seamless mobility domain over a distribution system.

In some aspects, the techniques described herein relate to an apparatus including: a network interface unit to communicate with one or more networks; and a processor of an access point (AP) configured to operate in a seamless mobility domain (SMD) that supports roaming of wireless stations (STAs) between APs of the SMD, the processor coupled to the network interface unit and configured to perform: encoding, into a first frame, AP pairwise transient key (PTK) rekeying options related to roaming of a STA, wherein the AP PTK rekeying options include one or more of (i) a before-roaming AP PTK rekeying option that indicates a first preference, a first requirement, or a first non-preference for PTK rekeying before the roaming, or (ii) an after-roaming AP PTK rekeying option that indicates a second preference, a second requirement, or a second non-preference for the PTK rekeying after the roaming; and causing the AP to transmit the first frame to the STA.

In some aspects, the techniques described herein relate to an apparatus, wherein: the before-roaming AP PTK rekeying option is selected from a set of before-roaming AP PTK rekeying options including: the AP requires the STA to perform the PTK rekeying before the roaming; the AP prefers the STA to perform the PTK rekeying before the roaming; the AP prefers that the STA does not perform the PTK rekeying before the roaming; and the AP has no preference for the PTK rekeying before the roaming.

In some aspects, the techniques described herein relate to an apparatus, wherein: the after-roaming AP PTK rekeying option is selected from a set of after-roaming AP PTK rekeying options including: the AP intends to perform the PTK rekeying after the roaming; the AP prefers that the PTK rekeying after the roaming is performed by the AP; the AP prefers that the PTK rekeying after the roaming is performed by the STA; the AP prefers that the PTK rekeying is not performed after the roaming by the AP or the STA; the AP performs the PTK rekeying after the roaming according to a STA requirement; and the AP has no preference for the PTK rekeying after the roaming.

In some aspects, the techniques described herein relate to an apparatus, wherein: the processor is configured to perform encoding by encoding, into the first frame, the before-roaming AP PTK rekeying option and the after-roaming AP PTK rekeying option.

In some aspects, the techniques described herein relate to a non-transitory computer readable medium encoded with instructions that, when executed by a processor of an access point (AP) configured to operate in a seamless mobility domain (SMD) that supports roaming of wireless stations (STAs) between APs of the SMD, causes the processor to perform: encoding, into a first frame, AP pairwise transient key (PTK) rekeying options related to roaming of a STA, wherein the AP PTK rekeying options include one or more of (i) a before-roaming AP PTK rekeying option that indicates a first preference, a first requirement, or a first non-preference for PTK rekeying before the roaming, or (ii) an after-roaming AP PTK rekeying option that indicates a second preference, a second requirement, or a second non-preference for the PTK rekeying after the roaming; and causing the AP to transmit the first frame to the STA.

In some aspects, the techniques described herein relate to a non-transitory computer readable medium, wherein: the before-roaming AP PTK rekeying option is selected from a set of before-roaming AP PTK rekeying options including: the AP requires the STA to perform the PTK rekeying before the roaming; the AP prefers the STA to perform the PTK rekeying before the roaming; the AP prefers that the STA does not perform the PTK rekeying before the roaming; and the AP has no preference for the PTK rekeying before the roaming.

In some aspects, the techniques described herein relate to a non-transitory computer readable medium, wherein: the after-roaming AP PTK rekeying option is selected from a set of after-roaming AP PTK rekeying options including: the AP intends to perform the PTK rekeying after the roaming; the AP prefers that the PTK rekeying after the roaming is performed by the AP; the AP prefers that the PTK rekeying after the roaming is performed by the STA; the AP prefers that the PTK rekeying is not performed after the roaming by the AP or the STA; the AP performs the PTK rekeying after the roaming according to a STA requirement; and the AP has no preference for the PTK rekeying after the roaming.

In some aspects, the techniques described herein relate to a non-transitory computer readable medium, wherein: the instructions to cause the processor to perform encoding include instructions to cause the processor to perform encoding, into the first frame, the before-roaming AP PTK rekeying option and the after-roaming AP PTK rekeying option.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method performed by an access point (AP) configured to operate in a seamless mobility domain (SMD) that supports roaming of wireless stations (STAs) between APs of the SMD, the method comprising:
encoding, into a first frame, AP pairwise transient key (PTK) rekeying options related to roaming of a STA, wherein the AP PTK rekeying options include one or more of (i) a before-roaming AP PTK rekeying option that indicates a first preference, a first requirement, or a first non-preference for PTK rekeying before the roaming, or (ii) an after-roaming AP PTK rekeying option that indicates a second preference, a second requirement, or a second non-preference for the PTK rekeying after the roaming; and
transmitting the first frame to the STA.

2. The method of claim 1, further comprising:
sharing, among the APs of the SMD, a PTK for the STA.

3. The method of claim 1, wherein:
the before-roaming AP PTK rekeying option is selected from a set of before-roaming AP PTK rekeying options including:
the AP requires the STA to perform the PTK rekeying before the roaming;
the AP prefers the STA to perform the PTK rekeying before the roaming;
the AP prefers that the STA does not perform the PTK rekeying before the roaming;
and
the AP has no preference for the PTK rekeying before the roaming.

4. The method of claim 1, wherein:
the after-roaming AP PTK rekeying option is selected from a set of after-roaming AP PTK rekeying options including:
the AP intends to perform the PTK rekeying after the roaming;
the AP prefers that the PTK rekeying after the roaming is performed by the AP;
the AP prefers that the PTK rekeying after the roaming is performed by the STA;
the AP prefers that the PTK rekeying is not performed after the roaming by the AP or the STA;
the AP performs the PTK rekeying after the roaming according to a STA requirement; and
the AP has no preference for the PTK rekeying after the roaming.

5. The method of claim 1, wherein:
encoding includes encoding, into the first frame, the before-roaming AP PTK rekeying option and the after-roaming AP PTK rekeying option.

6. The method of claim 1, wherein:
encoding further comprises indicating a PTK rekeying option which indicates to perform the PTK rekeying after the STA has performed a certain number of roams between the APs.

7. The method of claim 1, wherein:
encoding further comprises indicating a PTK rekeying option which indicates performing the PTK rekeying based on a certain time interval.

8. The method of claim 1, further comprising:
by the AP, performing AP PTK rekeying to generate a new PTK after an initial PTK has been generated, based on the AP PTK rekeying options transmitted by the AP.

9. The method of claim 1, further comprising:
by the STA, performing the PTK rekeying to generate a new PTK after an initial PTK has been generated, based on the AP PTK rekeying options transmitted by the AP.

10. The method of claim 1, further comprising, at the AP:
receiving, from the STA, a second frame encoded with STA PTK rekeying options related to the roaming of the STA, wherein the STA PTK rekeying options include one or more of (iii) a before-roaming STA PTK rekeying option that indicates a third preference, a third requirement, or a third non-preference for the PTK rekeying before the roaming, or (iv) an after-roaming STA PTK rekeying option that indicates a fourth preference, a fourth requirement, or a fourth non-preference STA for the PTK rekeying before the roaming.

11. The method of claim 10, further comprising, at the AP:
selecting, from the AP PTK rekeying options and the STA PTK rekeying options, a selected PTK rekeying option to be followed by the AP and the STA before or after the roaming.

12. The method of claim 11, further comprising, at the AP:
transmitting, to the STA, the selected PTK rekeying option; and
following the selected PTK rekeying option in connection with a roam by the STA.

13. The method of claim 11, wherein:
the AP PTK rekeying options are associated with first levels of restrictedness from most restricted to least restricted;
the STA PTK rekeying options are associated with second levels of the restrictedness from most to least restricted; and
selecting includes selecting based on the first levels of the restrictedness and the second levels of the restrictedness.

14. The method of claim 1, wherein:
transmitting includes transmitting the first frame as a beacon, a probe response, an association response, or a reassociation response.

15. The method of claim 1, wherein encoding includes:
encoding a first subfield of an AP PTK rekeying field with a first value indicative of the first preference, the first requirement, or the first non-preference for the PTK rekeying before the roaming; and
encoding a second subfield of the AP PTK rekeying field with a second value indicative of the second preference, the second requirement, or the second non-preference for rekeying after the roaming.

16. The method of claim 1, wherein encoding includes:
encoding an AP PTK rekeying field of the first frame as a bit map that has respective bits to indicate the first preference, the first requirement, or the first non-preference of the AP for the PTK rekeying before the roaming, and the second preference, the second requirement, or the second non-preference of the AP for the PTK rekeying after the roaming.

17. The method of claim 1, wherein:
the AP includes an AP multi-link device (MLD) and the STA includes a non-AP MLD.

18. The method of claim 1, further comprising, by the AP:
performing the PTK rekeying to generate a new PTK;
encrypting the new PTK to produce an encrypted PTK; and
distributing the encrypted PTK to other APs of the seamless mobility domain over a distribution system.

19. An apparatus comprising:
a network interface unit to communicate with one or more networks; and
a processor of an access point (AP) configured to operate in a seamless mobility domain (SMD) that supports roaming of wireless stations (STAs) between APs of the SMD, the processor coupled to the network interface unit and configured to perform:
encoding, into a first frame, AP pairwise transient key (PTK) rekeying options related to roaming of a STA, wherein the AP PTK rekeying options include one or more of (i) a before-roaming AP PTK rekeying option that indicates a first preference, a first requirement, or a first non-preference for PTK rekeying before the roaming, or (ii) an after-roaming AP PTK rekeying option that indicates a second preference, a second requirement, or a second non-preference for the PTK rekeying after the roaming; and
causing the AP to transmit the first frame to the STA.

20. The apparatus of claim 19, wherein:
the before-roaming AP PTK rekeying option is selected from a set of before-roaming AP PTK rekeying options including:
the AP requires the STA to perform the PTK rekeying before the roaming;
the AP prefers the STA to perform the PTK rekeying before the roaming;
the AP prefers that the STA does not perform the PTK rekeying before the roaming;
and
the AP has no preference for the PTK rekeying before the roaming.

21. The apparatus of claim 19, wherein:
the after-roaming AP PTK rekeying option is selected from a set of after-roaming AP PTK rekeying options including:
the AP intends to perform the PTK rekeying after the roaming;
the AP prefers that the PTK rekeying after the roaming is performed by the AP;
the AP prefers that the PTK rekeying after the roaming is performed by the STA;
the AP prefers that the PTK rekeying is not performed after the roaming by the AP or the STA;
the AP performs the PTK rekeying after the roaming according to a STA requirement; and
the AP has no preference for the PTK rekeying after the roaming.

22. The apparatus of claim 19, wherein:
the processor is configured to perform encoding by encoding, into the first frame, the before-roaming AP PTK rekeying option and the after-roaming AP PTK rekeying option.

23. A non-transitory computer readable medium encoded with instructions that, when executed by a processor of an access point (AP) configured to operate in a seamless mobility domain (SMD) that supports roaming of wireless stations (STAs) between APs of the SMD, causes the processor to perform:
encoding, into a first frame, AP pairwise transient key (PTK) rekeying options related to roaming of a STA, wherein the AP PTK rekeying options include one or more of (i) a before-roaming AP PTK rekeying option that indicates a first preference, a first requirement, or a first non-preference for PTK rekeying before the roaming, or (ii) an after-roaming AP PTK rekeying option that indicates a second preference, a second requirement, or a second non-preference for the PTK rekeying after the roaming; and
causing the AP to transmit the first frame to the STA.

24. The non-transitory computer readable medium of claim 23, wherein:
the before-roaming AP PTK rekeying option is selected from a set of before-roaming AP PTK rekeying options including:
the AP requires the STA to perform the PTK rekeying before the roaming;
the AP prefers the STA to perform the PTK rekeying before the roaming;
the AP prefers that the STA does not perform the PTK rekeying before the roaming;
and
the AP has no preference for the PTK rekeying before the roaming.

25. The non-transitory computer readable medium of claim 23, wherein:
the after-roaming AP PTK rekeying option is selected from a set of after-roaming AP PTK rekeying options including:
the AP intends to perform the PTK rekeying after the roaming;
the AP prefers that the PTK rekeying after the roaming is performed by the AP;
the AP prefers that the PTK rekeying after the roaming is performed by the STA;
the AP prefers that the PTK rekeying is not performed after the roaming by the AP or the STA;
the AP performs the PTK rekeying after the roaming according to a STA requirement; and
the AP has no preference for the PTK rekeying after the roaming.

26. The non-transitory computer readable medium of claim 23, wherein:
the instructions to cause the processor to perform encoding include instructions to cause the processor to perform encoding, into the first frame, the before-roaming AP PTK rekeying option and the after-roaming AP PTK rekeying option.
